(19) United States
(12) Patent Application Publication
(10) Pub. No.: US 2015/0104779 A1
(43) Pub. Date: Apr. 16, 2015

(54) FURNITURE OBJECTS INCLUDING WRITABLE ELEMENTS

(71) Applicant: Night and Day Furniture LLC, Vancouver, WA (US)

(72) Inventors: Steve KINGSTON, Battle Ground, WA (US); Mike GALLAWA, Ridgefield, WA (US); Howard PORTER, Kuala Lumpur (MY); Joel GROSSMAN, Petaling Jaya (MY)

(73) Assignee: Night and Day Furniture LLC, Vancouver, WA (US)

(21) Appl. No.: 14/299,533

(22) Filed: Jun. 9, 2014

Related U.S. Application Data
(63) Continuation-in-part of application No. 29/469,570, filed on Oct. 11, 2013.

(51) Int. Cl. B43L 1/00

(52) U.S. Cl. CPC B43L 1/008
USPC 434/409; 434/408; 434/425

(57) ABSTRACT

A furniture object includes a writable element. The writable element is configured to provide for nonpermanent markings. The writable element is integral to the structure and/or the functionality of the furniture object.

### CROSS-REFERENCE TO RELATED APPLICATIONS

This application is a continuation-in-part under 35 U.S.C. §120 of U.S. Design patent application No. 29/469,570, filed on Oct. 11, 2013, which is hereby incorporated by reference in its entirety for all purposes as if fully set forth herein.

### FIELD

The present disclosure relates generally to furniture having one or more writable elements, and more particularly to furniture having one or more writable elements where the at least one of the one or more writable elements is integral to the structure of the furniture.

### BACKGROUND

Furniture is often used in environments (e.g., residential, commercial, industrial, etc.) to support or otherwise aid in various human activities, such as seating, eating, sleeping, storage, and the like. Additionally, some furniture are used to hold objects at a convenient height for work (as horizontal surfaces above the ground), or for storage purposes. Furniture's functionality can also be enhanced or otherwise improved by the furniture's design. Additionally, furniture can act as a work of art or serve a symbolic purpose. However, the function, design, and/or artistic purpose of most furniture is usually a product of those who develop or otherwise manufacture the furniture.

Writable surfaces, such as chalkboards, dry-erase boards, and/or magnet boards are typically used for creating nonpermanent and/or erasable markings. Dry-erases boards or (alternatively, “markerboards”, “whiteboards”, “dry-wipe boards”, “pen boards”, “greaseboards”, and the like) are any glossy, usually white surface for nonpermanent markings. Whiteboards are analogous to chalkboards, allowing rapid marking and erasing of markings on their surface. Magnet boards use attachable magnets for nonpermanent markings. The magnets may be formed into a character, digit, or symbol, or may be formed into one of a variety of shapes, which may contain one or more markings, symbols, images, and the like.

### SUMMARY

At least one example embodiment relates to a furniture object having a writable element.

Example embodiments provide that the writable element is integral to the function of the furniture object.

Example embodiments provide that the nonpermanent markings are erasable.

Example embodiments provide that a portion of the furniture object including the writable element has a different composition than at least one other portion of the furniture frame.

Example embodiments provide that the portion of the furniture object including the writable element includes at least one of a whiteboard material, a magnet board material, and a chalk board material.

Example embodiments provide that the writable element includes a base layer and a coating layer.

Example embodiments provide that the base layer is one of a particle board, wood, steel, and aluminum, and the coating layer is one of a melamine resin, porcelain, ceramic, Polyvinyl chloride (PVC), epoxy, and the like.

Example embodiments provide that the furniture object is a bed frame and the writable element is at least one of a magnetic panel, dry-erase panel, and chalkboard panel assembled into the bed frame.

Example embodiments provide that the writable element is assembled into a structure of at least one of a headboard of the bed frame and a footboard of the bed frame.

Example embodiments provide that the furniture object is a bureau and the writable element is at least one of a magnetic panel, dry-erase panel, and chalkboard panel assembled into the bureau.

Example embodiments provide that the writable element is assembled into at least one of a structure of a side panel of the bureau, a structure of at least one drawer of the bureau, and a structure of a top surface of the bureau.

Example embodiments provide that the furniture object is an armoire and the writable element is at least one of a magnetic panel, dry-erase panel, and chalkboard panel assembled into the armoire.

Example embodiments provide that the writable element is assembled into at least one of a structure of a side panel of the armoire, a structure of at least one door of the armoire, and a structure of a top surface of the armoire.

Example embodiments provide that the furniture object is a foldable bed frame and the writable element is at least one of a magnetic panel, dry-erase panel, and chalkboard panel assembled into the foldable bed frame.

Example embodiments provide that the writable element is assembled into a structure of at least one armrest of the foldable bed frame.

Example embodiments provide that the furniture object is a table and the writable element is at least one of a magnetic panel, dry-erase panel, and chalkboard panel assembled into the table.

Example embodiments provide that the writable element is assembled into a structure of a top of the table.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front, left perspective view of a bed frame including a magnetic panel according to an example embodiment;

FIG. 2 is a front, left perspective view of a bed frame including a dry-erase panel according to an example embodiment;

FIG. 3 is a front, right perspective view of a bureau including a magnetic panel according to an example embodiment;

FIG. 4 is a side view and a front view of the bureau including a magnetic panel of FIG. 3;

FIG. 5 is a front, right perspective view of a bureau including a dry-erase panel according to an example embodiment;

FIG. 6 is a side view and a front view of the bureau including a dry-erase panel of FIG. 5;

FIG. 7 is a front, right perspective view of a foldable bed frame including a magnetic panel according to an example embodiment;

FIG. 8 is a front, right perspective view of a foldable bed frame including a dry-erase panel according to an example embodiment;

FIG. 9 is a front, right perspective view of a dining table including a magnetic panel according to an example embodiment;

FIG. 10 is a front, right perspective view of a dining table including a dry-erase panel according to an example embodiment;

FIG. 11 is a front, right perspective view of an armoire including a magnetic panel according to an example embodiment;

FIG. 12 is a side view and a front view of the armoire including a magnetic panel of FIG. 11;

FIG. 13 is a front, right perspective view of an armoire including a dry-erase panel according to an example embodiment;

FIG. 14 is a side view and a front view of the armoire including a dry-erase panel of FIG. 13;

FIG. 15 is a front, right perspective view of a square-shaped side table including a magnetic panel according to an example embodiment;

FIG. 16 is a front, right perspective view of a square-shaped side table including a dry-erase panel according to an example embodiment;

FIG. 17 is circular-shaped side table including a magnetic panel according to an example embodiment; and

FIG. 18 is a front, right perspective view of a circular-shaped side table including a dry-erase panel according to an example embodiment.

### DESCRIPTION

The following description is merely example in nature and is not intended to limit the present disclosure, application, or uses. It should be understood that throughout the drawings, corresponding reference numerals indicate like or corresponding parts and features.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein, the term “and/or” includes any and all combinations of one or more of the associated listed items.

It will be understood that, although the terms first, second, third etc. may be used herein to describe various elements, components, regions, portions, and/or sections, these elements, components, regions, portions, and/or sections should not be limited by these terms. These terms are only used to distinguish one element, component, region, portion, or section from another element, component, region, portion, or section. Thus, a first element, component, region, portion, or section discussed below could be termed a second element, component, region, portion, or section without departing from the scope of the example embodiments.

Certain terminology is used herein for purposes of reference only, and thus is not intended to be limiting. For example, terms such as “upper,” “lower,” “above,” “below,” “top,” “bottom,” “upward,” “downward,” “upwardly,” “downwardly,” “forward,” “rearward,” and the like refer to directions in the drawings to which reference is made. Terms such as “front,” “back,” “rear,” “bottom,” “side,” and the like describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second,” and other such numerical terms referring to structures do not imply a sequence or order unless clearly indicated by the context.

Example embodiments will now be described more fully with reference to the accompanying drawings. Example embodiments may, however, be embodied in many different forms and should not be construed as being limited to the example embodiments set forth herein. Rather, these example embodiments are provided so that this disclosure will be thorough, and will fully convey the concept of the invention to those skilled in the art.

FIG. 1 is a front, left perspective view of a bed frame 100A including magnetic panels 111A according to an example embodiment. As shown, bed frame 100A also includes frame 113, headboard 114, and footboard 115. Frame 113 includes slats 112. Headboard 114 and footboard 115 each include legs 110. Together, frame 113, slats 112, and the legs 110 of headboard 114 and footboard 115 may be used to support or otherwise position a mattress, bed-base (or alternatively a “boxspring”), and/or other like bedding pad. Additionally, both headboard 114 and footboard 115 each include magnetic panels 111A. Additionally, frame 113, slats 112, and the legs 110 of headboard 114 and footboard 115 may be manufactured out of various materials and/or fibers, including metal, wood, plastic, glass, rubber, and/or any other like materials that are natural and/or synthetic. Moreover, in various embodiments, frame 113, slats 112, legs 110, headboard 114, and footboard 115 may be of various sizes and/or shapes in order to support or otherwise position a mattress, bed-base (or alternatively a “boxspring”), and/or other like bedding pad. In various embodiments, other items and/or objects may be attached to bed frame 100A, such as wheels being attached to legs 110, one or more posts and/or columns (i.e., a four-poster bed), and the like.

According to various embodiments, magnetic panels 111A may be enclosed, incorporated, or otherwise included in each of headboard 114 and footboard 115, such that magnetic panels 111A fulfill or otherwise provide a structural purpose for headboard 114, footboard 115, and/or bedframe 100A. For instance, in various embodiments, magnetic panels 111A may be incorporated into each of headboard 114 and footboard 115 by framing the magnetic panels 111A within each of headboard 114 and footboard 115, building the magnetic panels 111A into spaces defined by the structure of each of headboard 114 and footboard 115, or magnetic panels 111A may be otherwise assembled into each of headboard 114 and footboard 115. Additionally, magnet panels 111A may be used as a panel in the construction and/or manufacture of bedframe 100A. In each of the aforementioned embodiments, magnetic panels 111A may provide, aid, or otherwise influence a load bearing effect of each of headboard 114 and footboard 115, and thus, bedframe 100A.

Additionally, in various embodiments, magnetic panels 111A may be mounted on, or otherwise connected to each of headboard 114 and footboard 115 by nails, bolts, glue, pins, snap-on devices, and/or any other like connector and/or adhesive. In some embodiments, magnetic panels 111A may be mounted on, or otherwise connected to each of headboard 114 and footboard 115 by way of static electricity. In such embodiments, the magnetic panels 111A may reinforce, aid, or otherwise influence a load bearing effect of each of headboard 114 and footboard 115, and thus, bedframe 100A. Thus, according to various embodiments, magnetic panels 111A are integral to the structure of headboard 114, footboard 115, and/or bedframe 100A.

Magnetic panels 111A may be manufactured out of various materials and/or fibers that incorporate a magnetic component. The magnetic component may be any material, or combinations of materials, that attracts other permanent magnetic materials (i.e., a magnetized material that creates its own persistent magnetic field) and/or any ferromagnetic materials (i.e., a material that may be attracted to a permanent magnet and/or that may be formed into a permanent magnet). In various embodiments, a combination of the aforementioned magnetic materials may be used in order to achieve the desired properties of a suitable magnetic material. Additionally, the magnetic component may be incorporated or otherwise included into one or more other materials and/or fibers, such as metal, wood, plastic, glass, rubber, and/or any other suitable materials. Moreover, in various embodiments, magnetic panels 111A may be of various sizes and/or shapes based on a shape, construction, or other like criterion of headboard 114 and footboard 115.

In various embodiments, magnetic panels 111A are also integral to the functionality of headboard 114, footboard 115, and/or bedframe 100A. In various embodiments, magnetic panels 111A allow headboard 114, footboard 115, and/or bedframe 100A to provide a function of creating or otherwise making nonpermanent markings. For example, magnet panels 111A may be configured to, by way of magnetism, allow for magnets and/or other like magnetized objects to be used for creating or otherwise making nonpermanent markings. In such embodiments, the magnets and/or other like magnetized objects may be formed into a character, digit, or symbol, or may be formed into one of a variety of shapes, which may contain one or more markings, symbols, images, and the like.

Furthermore, typical headboards and/or footboards may fulfill or otherwise perform a function of keeping one or more bedding items (e.g., pillows, blankets, sheets, and the like) on a bed. In various embodiments, where bedding items include one or more magnetized materials, magnet panels 111A may provide a function of keeping one or more bedding items on a bed. Typical headboards and/or footboards may include one or more storage spaces/containers (e.g., cubby holes, pigeon holes, and/or other like containers) and/or storage implements (e.g., hooks, clamps, and/or other like devices for holding an object in a fixed position) for storing items. In various embodiments, where storage spaces/containers and/or storage implements include one or more magnetized materials, magnet panels 111A may provide a function of adhering, attaching, or otherwise holding one or more storage spaces/containers and/or storage implements in a desired position and/or orientation. In such embodiments, a position and/or orientation of the storage spaces/containers and/or storage implements including one or more magnetized materials may be changed, altered, repositioned, and/or reoriented as desired. Additionally, where a bed frame is employed or otherwise used as a hospital bed, headboards and/or footboards may incorporate and/or include one or more critical care devices (e.g., peripheral I.V. catheters, infusion safety systems, temperature management devices, airway management, patient monitoring, ventilation devices, and/or other like critical care devices). In various embodiments, where critical care devices incorporate or otherwise include one or more magnetized materials, magnet panels 111A may provide a function of adhering, attaching, or otherwise holding one or more critical care devices in a desired position and/or orientation. In such embodiments, a position and/or orientation of the critical care devices including one or more magnetized materials may be changed, altered, repositioned, and/or reoriented as desired.

It should be noted that, although FIG. 1 shows magnetic panels 111A incorporated into headboard 114 and footboard 115 of bed frame 100A, in various embodiments, magnetic panels 111A may be incorporated into any other element of bed frame 100A and/or any other available space or other like portion of bed frame 100A.

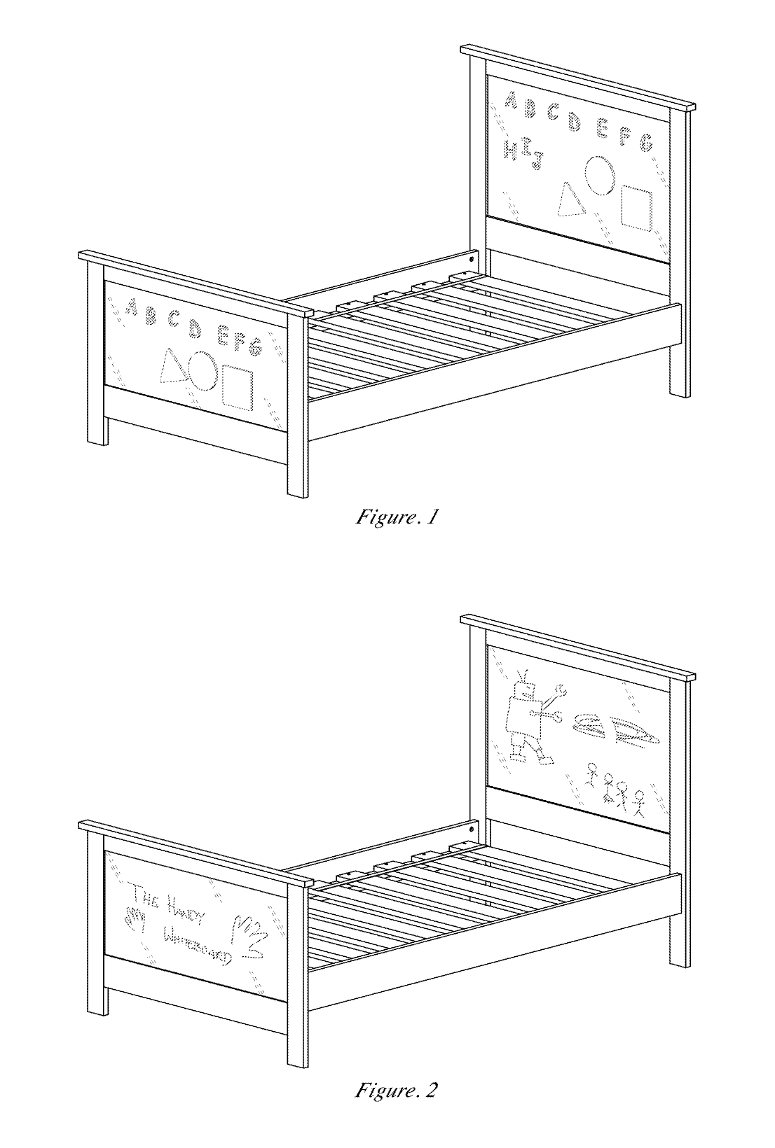

FIG. 2 is a front, left perspective view of a bed frame 100B including a dry-erase panels 111B according to an example embodiment. Similar to bed frame 100A as shown in FIG. 1, bed frame 100B includes frame 113, headboard 114, and footboard 115. For the sake of brevity, aspects of bed frame 100B that are similar or the same as bed frame 100A will not be described; and instead, the differences will be described.

As shown in FIG. 2, headboard 114 and footboard 115 each include dry-erase panels 111B. According to various embodiments, dry-erase panels 111B may be enclosed, incorporated, or otherwise included in each of headboard 114 and footboard 115, such that include dry-erase panels 111B fulfill, provide, or otherwise provide a structural purpose for headboard 114, footboard 115, and/or bedframe 100B. For instance, in various embodiments, dry-erase panels 111B may be incorporated into each of headboard 114 and footboard 115 by framing the dry-erase panels 111B within each of headboard 114 and footboard 115, building the dry-erase panels 111B into spaces defined by the structure of each of headboard 114 and footboard 115, or dry-erase panels 111B may be otherwise assembled into each of headboard 114 and footboard 115. Additionally, dry-erase panels 111B may be used as a panel in the construction and/or manufacture of bedframe 100B. In each of the aforementioned embodiments, dry-erase panels 111B may provide, aid, or otherwise influence a load bearing effect of each of headboard 114 and footboard 115, and thus, bedframe 100B. Additionally, frame 113, slats 112, legs 110, headboard 114, and footboard 115 may be manufactured out of various materials and/or fibers, including metal, wood, plastic, glass, rubber, and/or any other like materials that are natural and/or synthetic. Moreover, in various embodiments, frame 113, slats 112, and the legs 110 of headboard 114 and footboard 115 may be of various sizes and/or shapes in order to support or otherwise position a mattress, bed-base (or alternatively a “boxspring”), and/or other like bedding pad. In various embodiments, other items and/or objects may be attached to bed frame 100B, such as wheels being attached to legs 110, one or more posts and/or columns (i.e., a four-poster bed), and the like.

Additionally, in various embodiments, dry-erase panels 111B may be mounted on, or otherwise connected to each of headboard 114 and footboard 115 by nails, bolts, glue, pins, snap-on devices, and/or any other like connector and/or adhesive. In some embodiments, dry-erase panels 111B may be mounted on, or otherwise connected to each of headboard 114 and footboard 115 by way of static electricity. In such embodiments, the dry-erase panels 111B may reinforce, aid, or otherwise influence a load bearing effect of each of headboard 114 and footboard 115, and thus, bedframe 100B. Thus, according to various embodiments, include dry-erase panels 111B are integral to the structure of headboard 114, footboard 115, and/or bedframe 100B.

Dry-erase panels 111B may be manufactured out of various materials and/or fibers that incorporate a dry-erase component. The dry-erase component may be any material, or combinations of materials, that allows for the creation of nonpermanent markings. Such a dry-erase component may be made of at least one of melamine, aluminum, steel, hardcoat laminate, porcelain, enamel, ceramic, polyethylene terephthalate (PET), and/or other like suitable material. In various embodiments, a combination of aforementioned materials may be used in order to achieve the desired properties of a suitable material. The aforementioned materials may be used in combination with one or more paints and/or coatings, which include a dry-erase component, such as a white pigment, clear coat, and the like. Additionally, the dry-erase component may be incorporated or otherwise included into other materials and/or fibers, such materials as metal, wood, plastic, glass, rubber, and/or any other suitable materials. Moreover, in various embodiments, dry-erase panels 111B may be of various sizes and/or shapes based on a shape, construction, or other like criterion of headboard 114 and footboard 115.

In various embodiments, dry-erase panels 111B are also integral to the functionality of headboard 114, footboard 115, and/or bedframe 100B. In various embodiments, dry-erase panels 111B allow headboard 114, footboard 115, and/or bedframe 100B to provide a function of creating or otherwise making nonpermanent markings. For example, dry-erase panels 111B may be configured to allow for creating or otherwise making nonpermanent markings using a dry erasable marker or other like implement. Dry erasable markers (or alternatively, a “whiteboard markers” or a “whiteboard pens”) are non-permanent writing implements, which use an erasable ink that adheres to a writing surface of the dry-erase panels 111B without binding or being absorbed by the writing surface of the dry-erase panels 111B.

Furthermore, one or more adhesive materials may be used to adhere, attach, or otherwise hold one or more objects in a desired position and/or orientation. In various embodiments, where bedding items, storage spaces/containers and/or storage implements, and/or critical care devices include or otherwise incorporate one or more adhesive materials, the dry-erase panels 111B may provide a function of adhering, attaching, or otherwise holding one or more critical care devices in a desired position and/or orientation. In such embodiments, a position and/or orientation of the bedding items, storage spaces/containers and/or storage implements, and/or critical care devices including one or more adhesive materials may be changed, altered, repositioned, and/or reoriented as desired.

It should be noted that although bedframe 100B includes dry-erase panels 111B, according to various embodiments, bedframe 100B may alternatively include a chalkboard (or alternatively a “blackboard”) instead of dry-erase panels 111B. In such embodiments, chalkboard and/or blackboard material may be mounted on, or otherwise connected to each of headboard 114 and footboard 115 by nails, bolts, glue, pins, snap-on devices, and/or any other like connector and/or adhesive. In some embodiments, the chalkboard and/or blackboard material may be mounted on, or otherwise connected to each of headboard 114 and footboard 115 by way of static electricity. In some embodiments, the chalkboard and/or blackboard material may be painted on a surface of headboard 114 and/or footboard 115. In such embodiments, the chalkboard and/or blackboard material may be used in combination with one or more paints and/or coatings, which include a blackboard and/or chalkboard component. It should also be noted that, although FIG. 2 shows dry-erase panels 211B incorporated into headboard 114 and footboard 115 of bed frame 100B, in various embodiments, dry-erase panels 111B may be incorporated into any other element of bed frame 100B and/or any other available space or other like portion of bed frame 100B.

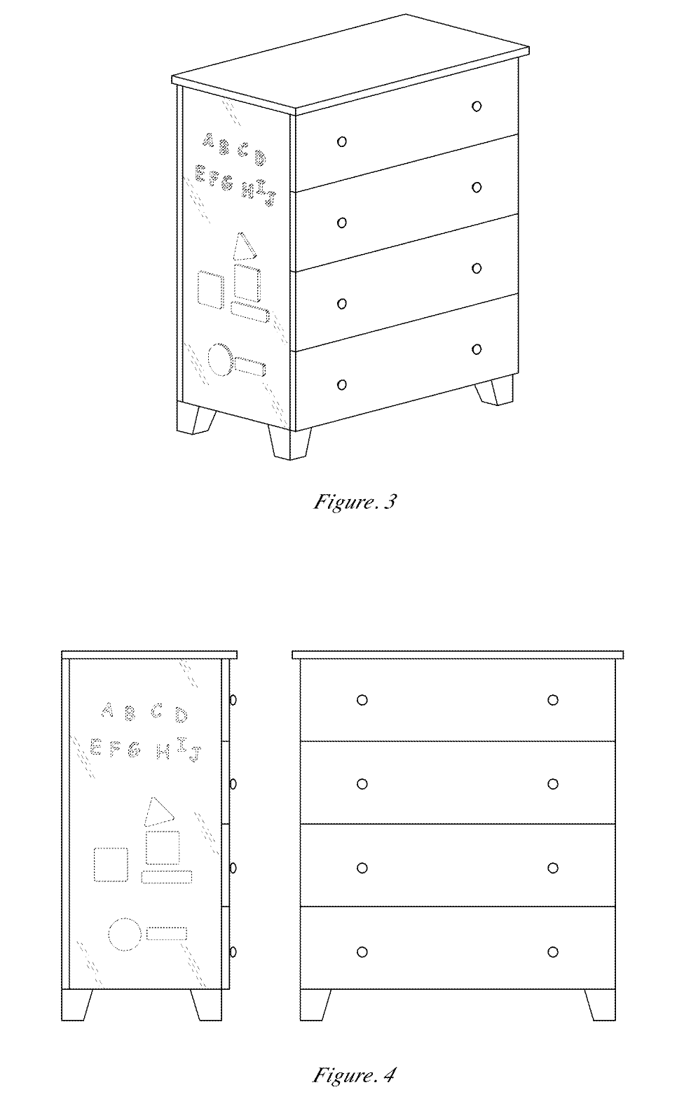

FIG. 3 is a front, right perspective view of a bureau 200A including a magnetic panel 211A according to an example embodiment. FIG. 4 is a side view and a front view of the bureau 200A including a magnetic panels 211A of FIG. 3 according to an example embodiment. As shown, bureau 200A also includes legs 210, drawers 212, and top 213. As shown, drawers 212 are vertically stacked and are enclosed by magnetic panels 211A and top 213. Together, magnetic panels 211A and top 213 enclose drawers 212, which may be used to store one or more items. In various embodiments, drawers 212 may be placed horizontally in addition to, or alternatively to being stacked vertically (not shown). Additionally, legs 210, drawers 212, and top 213 may be manufactured out of various materials and/or fibers, including metal, wood, plastic, glass, rubber, and/or any other suitable materials. Furthermore, a combination of numerous materials may be used in order to achieve the desired properties of a suitable material. Moreover, in various embodiments, legs 210, drawers 212, and top 213 may be of various sizes and/or shapes in order to create an enclosure for storing one or more items. In various embodiments, other items and/or objects may be attached to bureau 200A, such as wheels being attached to legs 210, a mirror above top 213, and the like.

According to various embodiments, magnetic panels 211A may be incorporated or otherwise included in bureau 200A, such that magnetic panels 211A fulfill or otherwise provide a structural purpose for bureau 200A. For instance, in various embodiments, magnetic panels 211A may be incorporated into each bureau 200A by framing the magnetic panels 211A within or between legs 210 and top 213, building the magnetic panels 211A into spaces defined by the structure of each of bureau 200A, or magnetic panels 211A may be otherwise assembled into bureau 200A. Additionally, magnetic panels 211A may be used as a panel in the construction and/or manufacture of bureau 200A. In each of the aforementioned embodiments, magnetic panels 211A may provide, aid, or otherwise influence a load bearing effect of bureau 200A. Additionally, in various embodiments, magnetic panels 211A may be mounted on, or otherwise connected to bureau 200A by nails, bolts, glue, pins, snap-on devices and/or any other like connector and/or adhesive. In some embodiments, the magnetic panels 211A may be mounted on, or otherwise connected to bureau 200A by way of static electricity. In such embodiments, the magnetic panels 211A may reinforce, aid, or otherwise influence a load bearing effect of bureau 200A. Thus, according to various embodiments, magnetic panels 211A are incorporated or otherwise included in bureau 200A, such that magnetic panels 211A are integral to the structure of bureau 200A.

Magnetic panels 211A may be the same or similar as magnetic panels 111A as discussed above with respect to bed frame 100A. Thus, magnetic panels 211A may include the same or similar properties as magnetic panels 111A, and may be constructed or otherwise manufactured in a similar of same fashion as magnetic panels 111A.

Additionally, magnetic panels 211A are also integral to the functionality of bureau 200A. For example, magnetic panels 211A, drawers 212, and/or top 213 fulfill or otherwise provide a storage function for bureau 200A. In various embodiments, magnetic panels 211A may be the same or similar to magnetic panels 111A, and thus, allow bureau 200A to provide a function of creating or otherwise making nonpermanent markings. According to various embodiments, bureau 200A may be used for storing clothing and/or other like items. In various embodiments, where storage spaces/containers, storage implements, and/or other like apparatuses which include one or more magnetized materials, magnet panels 211A may provide a function of adhering, attaching, or otherwise holding the storage spaces/containers, storage implements, and/or other like apparatuses in a desired position and/or orientation. In such embodiments, a position and/or orientation of the storage spaces/containers, storage implements, and/or other like apparatuses including one or more magnetized materials may be changed, altered, repositioned, and/or reoriented as desired.

It should be noted that, although FIGS. 3-4 show magnetic panels 211A incorporated into side panels of bureau 200A, in various embodiments, magnetic panels 211A may be incorporated into any other element of bureau 200A, such as a structure of at least one drawer of the bureau 200A, a structure of a top surface of the bureau 200A, and/or any other available space or other like portion of bureau 200A.

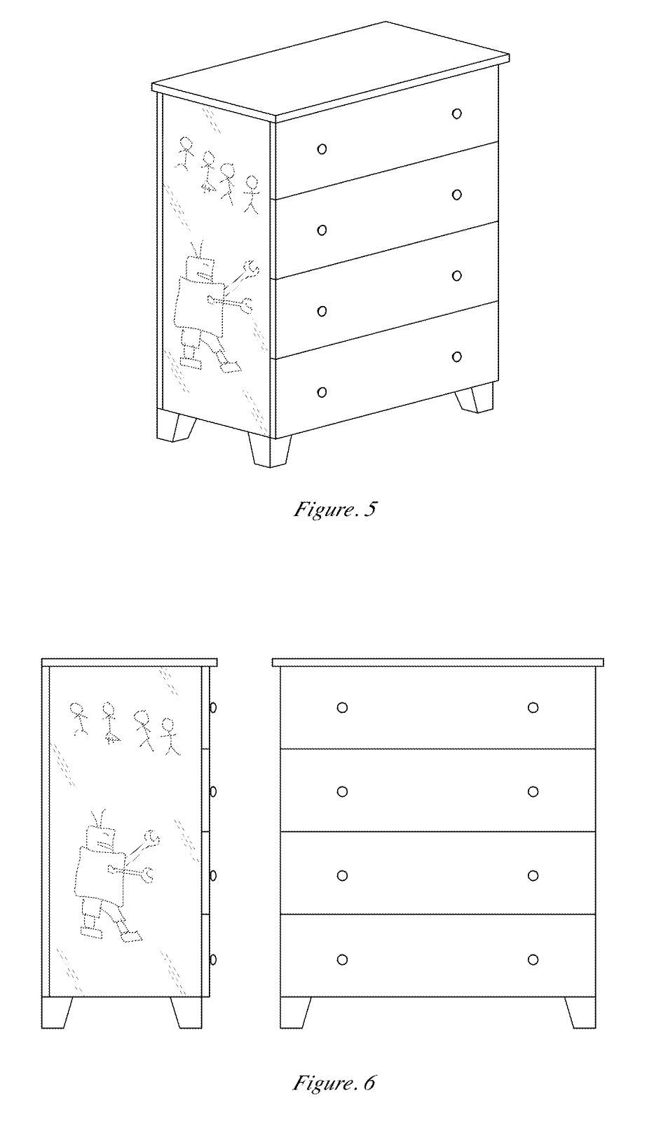

FIG. 5 is a front, right perspective view of a bureau 200B including a dry-erase panel 211B according to an example embodiment. FIG. 6 is a side view and a front view of the bureau 200B including a dry-erase panels 211B of FIG. 5 according to an example embodiment. Similar to bureau 200A as shown in FIGS. 3-4, bureau 200B includes legs 210, drawers 212, and top 213. For the sake of brevity, aspects of bureau 200B that are similar or the same as bureau 200B will not be described; and instead, the differences will be described.

Similar to magnetic panels 211A in bureau 200A, as discussed above with respect to FIGS. 3-4, according to various embodiments, dry-erase panels 211B may be incorporated or otherwise included in bureau 200B, such that dry-erase panels 211B are integral to the structure of bureau 200B. For instance, in various embodiments, dry-erase panels 211B may be incorporated into each bureau 200B by framing the dry-erase panels 211B within or between legs 210 and top 213, building the dry-erase panels 211B into spaces defined by the structure of each of bureau 200B, or dry-erase panels 211B may be otherwise assembled into bureau 200B. Additionally, dry-erase panels 211B may be used as a panel in the construction and/or manufacture of bureau 200B. In each of the aforementioned embodiments, dry-erase panels 211B may provide, aid, or otherwise influence a load bearing effect of bureau 200B. Additionally, in various embodiments, dry-erase panels 211B may be mounted on, or otherwise connected to bureau 200B by nails, bolts, glue, pins, snap-on devices, and/or any other like connector and/or adhesive. In some embodiments, the dry-erase panels 211B may be mounted on, or otherwise connected to bureau 200B by way of static electricity. In such embodiments, the dry-erase panels 211B may reinforce, aid, or otherwise influence a load bearing effect of bureau 200A.

Dry-erase panels 211B may be the same or similar as dry-erase panels 111B as discussed above with respect to bed frame 100B. Thus, dry-erase panels 211B may include the same or similar properties as dry-erase panels 111B, and may be constructed or otherwise manufactured in a similar of same fashion as dry-erase panels 111B.

Additionally, dry-erase panels 211B are integral to the functionality of bureau 200A. In various embodiments, dry-erase panels 211B allow bureau 200A to provide a function of creating or otherwise making nonpermanent markings. For example, dry-erase panels 211B may be configured to allow for creating or otherwise making nonpermanent markings using a dry erasable marker or other like implement. Additionally, dry-erase panels 211B may be similar or the same as dry-erase panels 111B, and thus, dry-erase panels 211B may be made of the same or similar materials as discussed above with respect to dry-erase panels 111B.

Furthermore, one or more adhesive materials may be used to adhere, attach, or otherwise hold one or more objects in a desired position and/or orientation. In various embodiments, where storage spaces/containers, storage implements, and/or other like apparatuses include or otherwise incorporate one or more adhesive materials, the dry-erase panels 211B may provide a function of adhering, attaching, or otherwise holding one or more storage spaces/containers, storage implements, and/or other like apparatuses in a desired position and/or orientation. In such embodiments, a position and/or orientation of the storage spaces/containers, storage implements, and/or other like apparatuses including one or more adhesive materials may be changed, altered, repositioned, and/or reoriented as desired.

It should be noted that although bureau 200A includes dry-erase panels 211B, according to various embodiments, bureau 200A may alternatively include a chalkboard (or alternatively a “blackboard”) instead of dry-erase panels 211B. In such embodiments, the chalkboard and/or blackboard material may be the same or similar as discussed above with respect to bed frame 100B. Additionally, it should be noted that, although FIGS. 5-6 show dry-erase panels 211B incorporated into side panels of bureau 200B, in various embodiments, dry-erase panels 211B may be incorporated into a structure of at least one drawer of the bureau 200B, and a structure of a top surface of the bureau 200B.

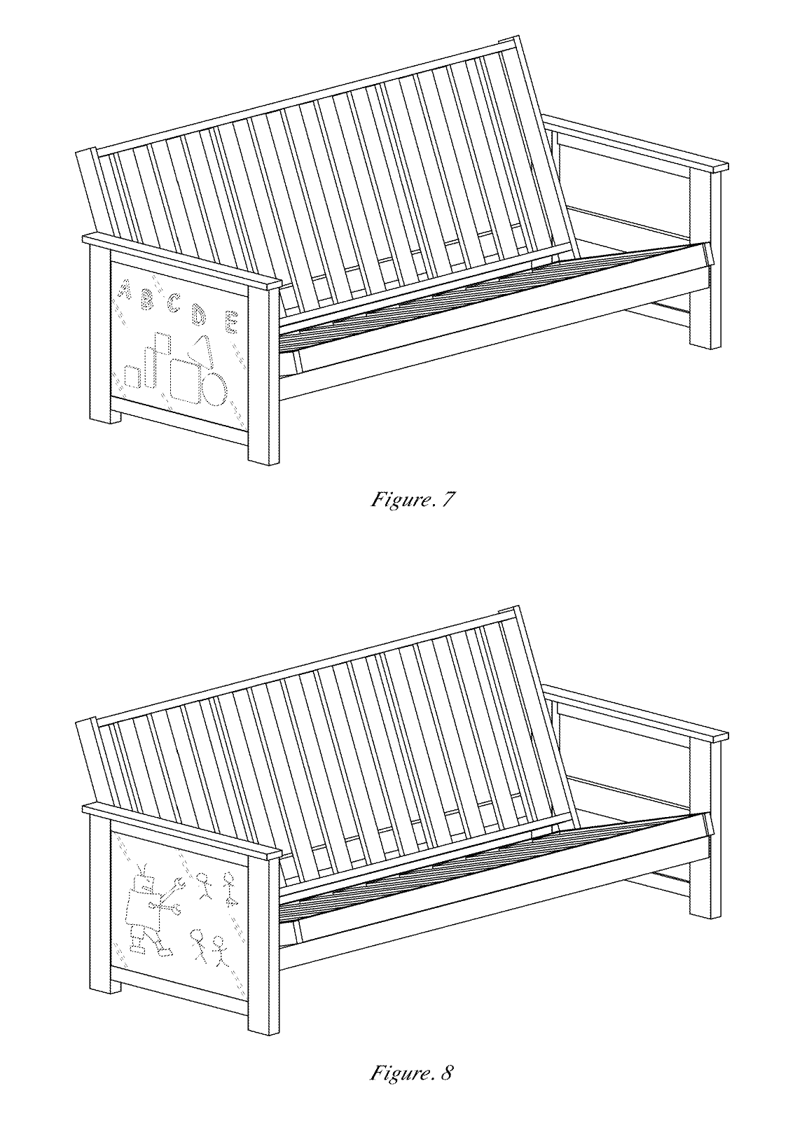

FIG. 7 is a front, right perspective view of foldable bed frame 300A including a magnetic panels 311A according to an example embodiment. FIG. 8 is a front, right perspective view of foldable bed frame 300A including a dry-erase panels 311B according to an example embodiment. As shown, foldable bed frames 300A-300B (hereinafter “foldable bed frame 300A/B”) also include frame 313 and armrests 314. Frame 313 includes slats 312. Armrests 314 include legs 310. Together, frame 313, slats 312, and the legs 310 of armrests 314 may be used to support or otherwise position a mattress, futon, or other like bed pad. Additionally, armrests 314 each include magnetic panels 311A. Frame 313 may be a wood, plastic, and/or metal frame that, when folded, allows a mattress, futon, or other like bed pad resting on slats 312 to be used as a couch. When flattened, a mattress, futon, or other like bed pad resting on slats 312 may be used as a bed.

According to various embodiments, magnetic panels 311A may be the same or similar to magnetic panels 111A, and thus, magnetic panels 311A may provide a structural purpose such that magnetic panels 311A are integral to the structure of foldable bed frame 300A in a same or similar fashion as discussed above with respect to bedframe 100A. Additionally, magnetic panels 311A may provide a construction purpose such that magnetic panels 311A are integral to the construction and/or manufacture of foldable bed frame 300A in a same or similar fashion as discussed above with respect to bedframe 100A. Furthermore, magnetic panels 311A may be the same or similar to magnetic panels 111A, and thus, magnetic panels 311A may be integral to the functionality of foldable bed frame 300A in a same or similar fashion as discussed above with respect to bedframe 100A.

Magnetic panels 311A may be the same or similar as magnetic panels 111A as discussed above with respect to bed frame 100A. Thus, magnetic panels 311A may include the same or similar properties as magnetic panels 111A, and may be constructed or otherwise manufactured in a similar of same fashion as magnetic panels 111A.

According to various embodiments, dry-erase panels 311B may be the same or similar to dry-erase panels 111B, and thus, dry-erase panels 311B may provide a structural purpose such that dry-erase panels 311B are integral to the structure of foldable bed frame 300B in a same or similar fashion as discussed above with respect to bedframe 100B. Additionally, dry-erase panels 311B may provide a construction purpose such that dry-erase panels 311B are integral to the construction and/or manufacture of foldable bed frame 300B in a same or similar fashion as discussed above with respect to bedframe 100B. Furthermore, dry-erase panels 311B may be the same or similar to dry-erase panels 111B, and thus, dry-erase panels 311B may be integral to the functionality of foldable bed frame 300B in a same or similar fashion as discussed above with respect to bedframe 100B.

Dry-erase panels 311B may be the same or similar as dry-erase panels 111B as discussed above with respect to bed frame 100B. Thus, dry-erase panels 311B may include the same or similar properties as dry-erase panels 111B, and may be constructed or otherwise manufactured in a similar of same fashion as dry-erase panels 111B.

It should be noted that although foldable bed frame 300A includes magnetic panels 311A and foldable bed frame 300B includes dry-erase panels 311B, according to various embodiments, foldable bed frames 300A-300B may alternatively include a chalkboard (or alternatively a “blackboard”) instead of magnetic panels 311A and/or dry-erase panels 311B. In such embodiments, the chalkboard and/or blackboard material may be the same or similar as discussed above with respect to bed frame 100B. It should also be noted that, although FIGS. 7-8 show magnetic panels 311A and/or dry-erase panels 311B incorporated into armrests 314 of foldable bed frames 300A-300B, in various embodiments, magnetic panels 311A and/or dry-erase panels 311B may be incorporated into any other element of foldable bed frames 300A-300B and/or any other available space or other like portion of foldable bed frames 300A-300B.

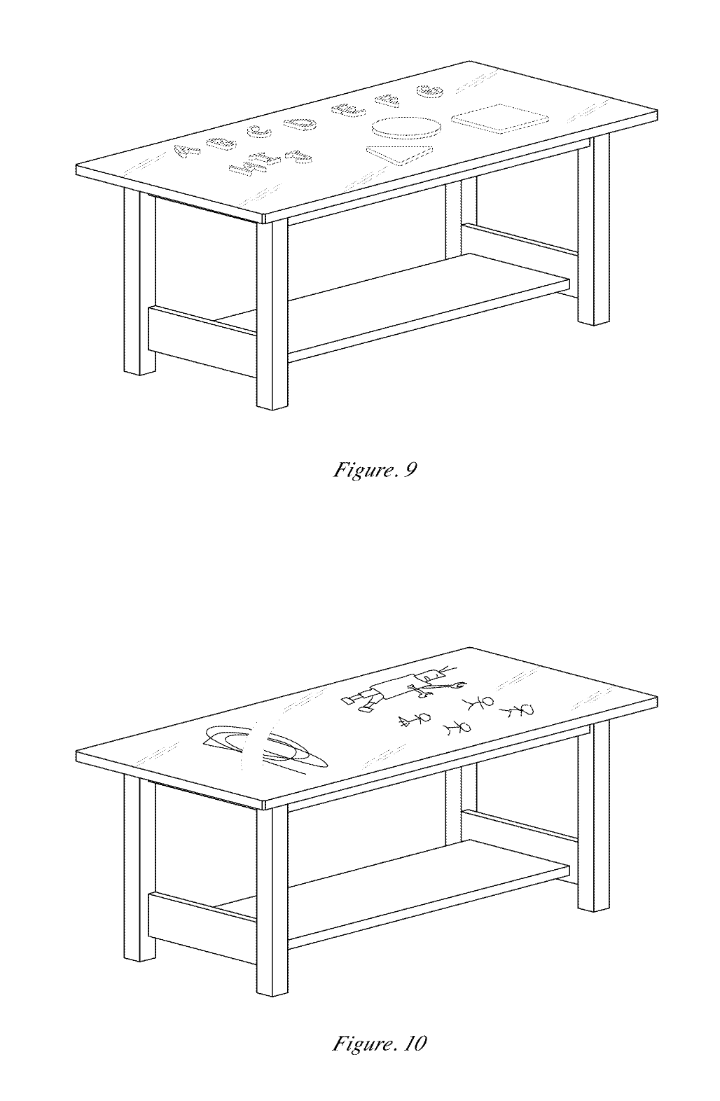

FIG. 9 is a front, right perspective view of a dining table 400A including magnetic panel 411A according to an example embodiment. FIG. 10 is a front, right perspective view of dining table 400B including dry-erase panel 411B according to an example embodiment. Dining tables 400A-400B each include legs 410, top 412, and (optionally) support 413. Together, legs 410 and top 412 allow dining tables 400A-400B to provide a substantially flat and/or substantially horizontal surface (e.g., top 412) used to support one or more objects for storage, show, and/or manipulation. Support 413 is connected to legs 410. The support 413 may provide stability for the top 412 and/or provide additional storage space for dining tables 400A-400B. As shown support 413 may be in a substantially flat and/or formed in a rectangular shape. However, in some embodiments, support 413 may be in a columnar shape, cylindrical shape, and/or other like shape. In some embodiments, alternative to legs 410 and/or support 413, one or more portions dining tables 400A-400B may be supported by a wall and/or suspended from above (not shown).

According to various embodiments, magnetic panel 411A and dry-erase panel 411B may be enclosed, incorporated, or otherwise included in dining tables 400A and 400B, respectively, such that magnetic panel 411A and dry-erase panel 411B fulfill or otherwise provide a structural purpose for dining tables 400A-400B. For instance, in various embodiments, magnetic panel 411A and dry-erase panel 411B may be incorporated into dining tables 400A-400B by framing magnetic panel 411A and dry-erase panel 411B within top 412, building the magnetic panel 411A and dry-erase panel 411B into spaces defined by the structure of each of dining tables 400A-400B, or magnetic panel 411A and dry-erase panel 411B may be otherwise assembled into dining tables 400A-400B. Additionally, magnetic panel 411A and dry-erase panel 411B may be used as a panel in the construction and/or manufacture of dining tables 400A-400B. In each of the aforementioned embodiments, magnetic panel 411A and dry-erase panel 411B may provide, aid, or otherwise influence a load bearing effect for one or more objects resting on top 412, and thus, dining tables 400A-400B.

Additionally, in various embodiments, magnetic panel 411A and dry-erase panel 411B may be mounted on, or otherwise connected to top 412 by nails, bolts, glue, pins, snap-on devices, and/or any other like connector and/or adhesive. In some embodiments, the magnetic panel 411A and/or the dry-erase panel 411B may be mounted on, or otherwise connected to each of dining tables 400A-400B by way of static electricity. In such embodiments, the magnetic panel 411A and dry-erase panel 411B may reinforce, aid, or otherwise influence a load bearing effect of one or more objects resting on top 412, and thus, dining tables 400A-400B. Thus, according to various embodiments, magnetic panel 411A and dry-erase panel 411B are integral to the structure of top 412 and/or dining tables 400A-400B.

Magnetic panels 411A may be the same or similar as magnetic panels 111A as discussed above with respect to bed frame 100A. Thus, magnetic panels 411A may include the same or similar properties as magnetic panels 111A, and may be constructed or otherwise manufactured in a similar of same fashion as magnetic panels 111A. Moreover, dry-erase panels 411B may be the same or similar as dry-erase panels 111B as discussed above with respect to bed frame 100B. Thus, dry-erase panels 411B may include the same or similar properties as dry-erase panels 111B, and may be constructed or otherwise manufactured in a similar of same fashion as dry-erase panels 111B.

Additionally, magnetic panel 411A and dry-erase panel 411B are also integral to the functionality of dining tables 400A-400B. In various embodiments, magnetic panel 411A and dry-erase panel 411B may be the same or similar to magnetic panel 111A and dry-erase panel 111B, respectively, and allow dining tables 400A-400B to provide a function of creating or otherwise making nonpermanent markings in a same or similar fashion as discussed above with respect to magnetic panel 111A and dry-erase panel 111B.

Furthermore, as discussed above dining tables 400A-400B may provide a substantially flat and/or substantially horizontal surface (e.g., top 412) used to support one or more objects for storage, show, and/or manipulation. In such embodiments, dining tables 400A-400B may allow for seated persons to eat meals, display objects, and/or store objects. In various embodiments, where eating implements (e.g., dishware and/or tableware, cutlery and/or silverware, and or the like) and/or other like objects include one or more magnetized materials and/or one or more adhesive materials, magnetic panel 411A and/or dry-erase panel 411B may provide a function of keeping one or more eating implements and/or other like objects on top 213 and/or dining tables 400A-400B. Additionally, in various embodiments, one or more storage/display containers (e.g., buckets, bowls, and/or other like containers), storage/display implements (e.g., hooks, clamps, and/or other like devices for holding an object in a fixed position) for storing/displaying objects may include one or more magnetized materials and/or one or more adhesive materials. In such embodiments, magnetic panel 411A and/or dry-erase panel 411B may provide a function of adhering, attaching, or otherwise holding one or more storage/display containers and/or storage/display implements in a desired position and/or orientation on top 213 and/or dining tables 400A-400B.

It should be noted that, although FIGS. 9-10 show magnetic panels 411A and dry-erase panels 411B incorporated into top 413 of dining tables 400A-400B, in various embodiments, magnetic panels 411A and dry-erase panels 411B may be incorporated into other elements of dining tables 400A-400B, such as a structure of support 413, and/or any other available space or other like portion of dining tables 400A-400B.

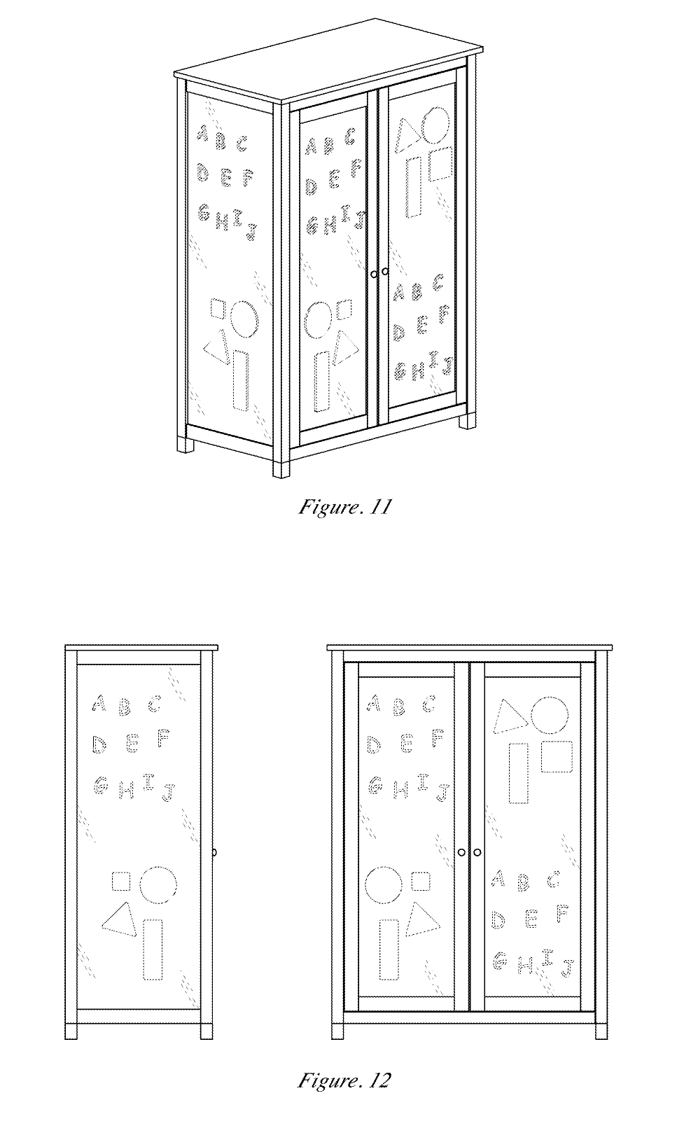

FIG. 11 is a front, right perspective view of armoire 500A including magnetic panels 511A according to an example embodiment. FIG. 12 is a side view and a front view of armoire 500A including a magnetic panels 511A of FIG. 11 according to an example embodiment. As shown, armoire 500A also includes legs 510, doors 512, and top 513. As shown, doors 512 are attached to magnetic panels 511A and top 513 creating a rectangular-shaped enclosure. In various embodiments, armoire 500A may be box and/or squared shaped. In various embodiments, armoire 500A may include one or more drawers on the inside or the enclosure created by doors 512, magnetic panels 511A, and top 513 (not shown). In some embodiments, one or more drawers may be vertically stacked on top of, or underneath doors 512 (not shown). In some embodiments, armoire 500A may be a stand-alone structure, while in other embodiments, armoire 500A may be built into a wall or otherwise attached to one or more walls. Armoire 500A may be made of wood, plastic, metal, or other like materials.

According to various embodiments, magnetic panels 511A may be the same or similar to magnetic panels 211A, and thus, magnetic panels 511A may provide a structural purpose such that magnetic panels 511A are integral to the structure of armoire 500A in a same or similar fashion as discussed above with respect to bureau 200A. Additionally, magnetic panels 511A may provide a construction purpose such that magnetic panels 511A are integral to the construction and/or manufacture of armoire 500A in a same or similar fashion as discussed above with respect to armoire 500A. Furthermore, magnetic panels 511A may be the same or similar to magnetic panels 211A, and thus, magnetic panels 511A may be integral to the functionality of armoire 500A in a same or similar fashion as discussed above with respect to bureau 200A.

Magnetic panels 511A may be the same or similar as magnetic panels 111A as discussed above with respect to bed frame 100A. Thus, magnetic panels 511A may include the same or similar properties as magnetic panels 111A, and may be constructed or otherwise manufactured in a similar of same fashion as magnetic panels 111A.

It should be noted that, although FIGS. 11-12 show magnetic panels 511A incorporated into doors 512 and side panels of armoire 500A, in various embodiments, magnetic panels 511A may be incorporated into other elements of armoire 500A, such as a structure of top 513, and/or any other available space or other like portion of armoire 500A.

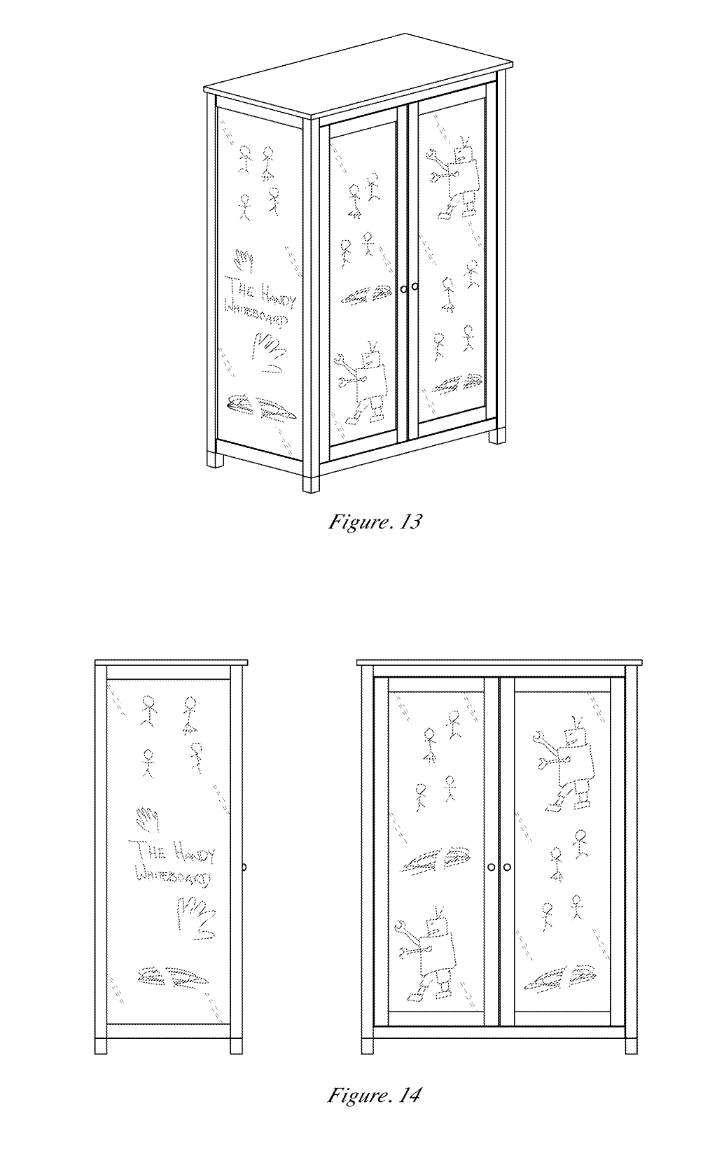

FIG. 13 is a front, right perspective view of armoire 500B including a dry-erase panels 511B according to an example embodiment. FIG. 14 is a side view and a front view of the armoire 500B including dry-erase panels 511B of FIG. 13 according to an example embodiment. Similar to armoire 500A as shown in FIGS. 11-12, armoire 500B includes legs 510, doors 512, and top 513. For the sake of brevity, aspects of armoire 500B that are similar or the same as armoire 500A will not be described; and instead, the differences will be described.

According to various embodiments, dry-erase panels 511B may be the same or similar to dry-erase panels 211B, and thus, dry-erase panels 511B may provide a structural purpose such that dry-erase panels 511B are integral to the structure of armoire 500B in a same or similar fashion as discussed above with respect to bureau 200B. Additionally, dry-erase panels 511B may provide a construction purpose such that dry-erase panels 511B are integral to the construction and/or manufacture of armoire 500B in a same or similar fashion as discussed above with respect to armoire 500B. Furthermore, dry-erase panels 511B may be the same or similar to dry-erase panels 511A, and thus, dry-erase panels 511B may be integral to the functionality of armoire 500B in a same or similar fashion as discussed above with respect to bureau 200B.

Dry-erase panels 511B may be the same or similar as dry-erase panels 111B as discussed above with respect to bed frame 100B. Thus, dry-erase panels 511B may include the same or similar properties as dry-erase panels 111B, and may be constructed or otherwise manufactured in a similar of same fashion as dry-erase panels 111B.

It should be noted that although armoire 500B includes dry-erase panels 511B, according to various embodiments, armoire 500B may alternatively include a chalkboard (or alternatively a “blackboard”) instead of dry-erase panels 511B. In such embodiments, the chalkboard and/or blackboard material may be the same or similar as discussed above with respect to bed frame 100B. It should also be noted that, although FIGS. 13-14 show dry-erase panels 511B incorporated into doors 512 and side panels of armoire 500B, in various embodiments, dry-erase panels 511B may be incorporated into other elements of armoire 500B, such as a structure of top 513, and/or any other available space or other like portion of armoire 500B.

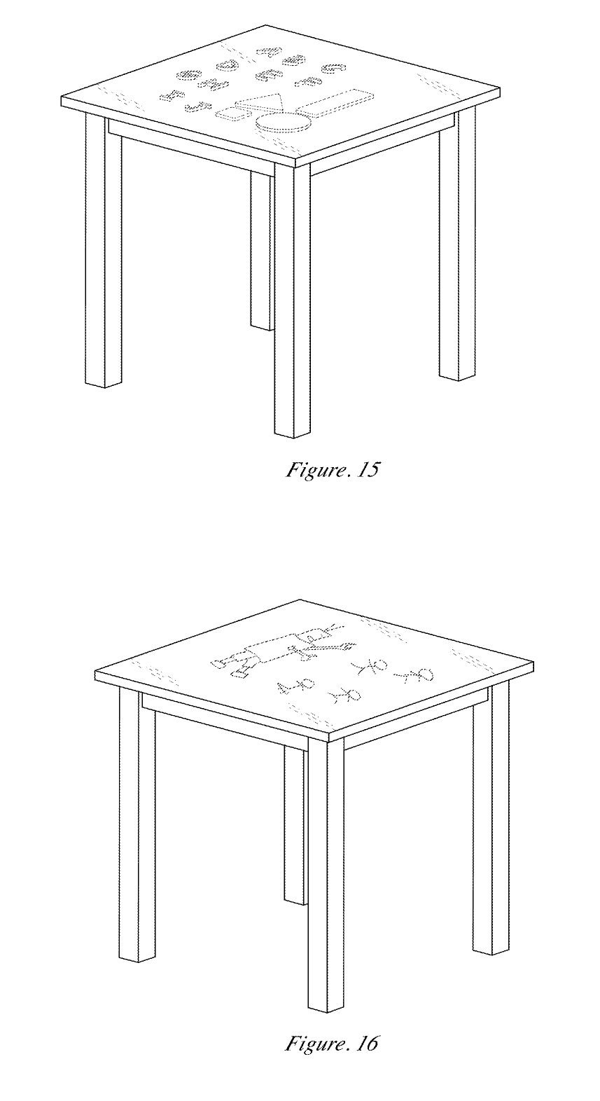

FIG. 15 is a front, right perspective view of a square-shaped side table 600A-1 including a magnetic panel 611A according to an example embodiment. FIG. 16 is a front, right perspective view of a square-shaped side table 600B-1 including a dry-erase panel 611B according to an example embodiment. Square-shaped side tables 600A-1-600B-1 each include legs 610 and top 612. Together, legs 610 and top 612 allow square-shaped side tables 600A-1-600B-1 to provide a substantially flat and/or substantially horizontal surface (e.g., top 612) used to support one or more objects for storage, show, and/or manipulation. Although not shown, a support may be connected to legs 610 underneath top 612 in order to provide stability for the top 612 and/or additional storage space for square-shaped side tables 600A-1-600B-1.

According to various embodiments, magnetic panel 611A-1 and dry-erase panel 611B-1 may be the same or similar to magnetic panel 411A and dry-erase panel 411B, respectively. Thus, magnetic panel 611A-1 and dry-erase panel 611B-1 may provide a structural purpose such that magnetic panel 611A-1 and dry-erase panel 611B-1 are integral to the structure of square-shaped side tables 600A-1-600B-1 in a same or similar fashion as discussed above with respect to dining tables 400A-400B. Additionally, magnetic panel 611A-1 and/or dry-erase panel 611B-1 may provide a construction purpose such that magnetic panel 611A-1 and/or dry-erase panel 611B-1 are integral to the construction and/or manufacture of side tables 600A-1-600B-1 in a same or similar fashion as discussed above with respect to dining tables 400A-400B. Furthermore, magnetic panel 611A-1 and dry-erase panel 611B-1 may be the same or similar to magnetic panels 411A and dry-erase panel 411B, respectively. Thus, magnetic panels 611A-1 dry-erase panel 611B-1 may be integral to the functionality of square-shaped side tables 600A-1-600B-1 in a same or similar fashion as discussed above with respect to dining tables 400A-400B.

Magnetic panels 611A-1 may be the same or similar as magnetic panels 111A as discussed above with respect to bed frame 100A. Thus, magnetic panels 611A-1 may include the same or similar properties as magnetic panels 111A, and may be constructed or otherwise manufactured in a similar of same fashion as magnetic panels 111A. Moreover, dry-erase panels 611B-1 may be the same or similar as dry-erase panels 111B as discussed above with respect to bed frame 100B. Thus, dry-erase panels 611B-1 may include the same or similar properties as dry-erase panels 111B, and may be constructed or otherwise manufactured in a similar of same fashion as dry-erase panels 111B.

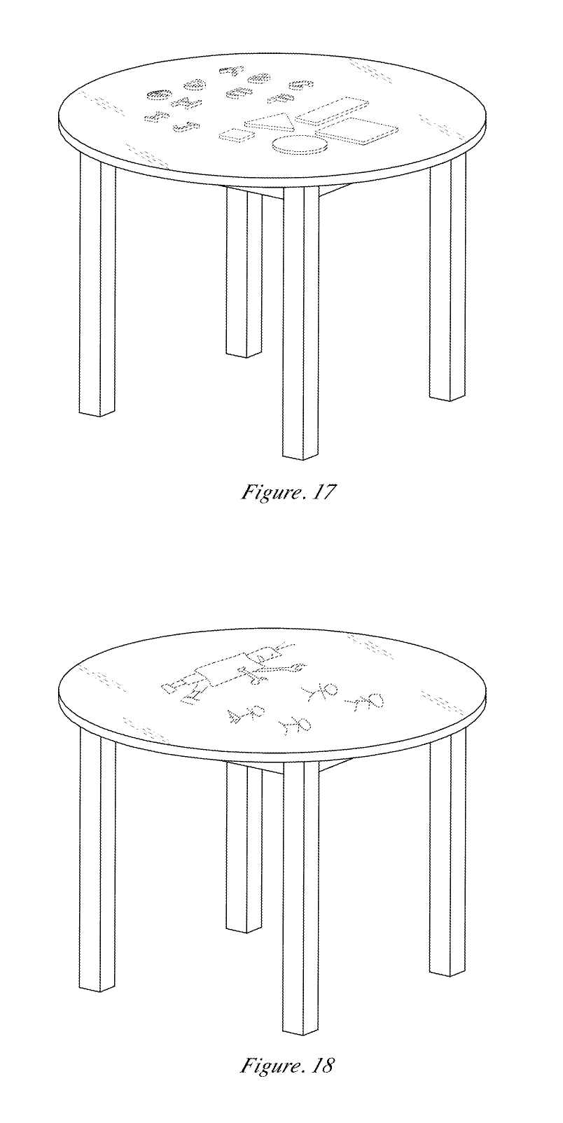

FIG. 17 is circular-shaped side table 600A-2 including a magnetic panel 611A-2 according to an example embodiment. FIG. 18 is a front, right perspective view of a circular-shaped 600B-2 side table including a dry-erase panel 600B-2 according to an example embodiment. Circular-shaped side tables 600A-2-600B-2 each include legs 610 and top 612. Together, legs 610 and top 612 allow circular-shaped side tables 600A-2-600B-2 to provide a substantially flat and/or substantially horizontal surface (e.g., top 612) used to support one or more objects for storage, show, and/or manipulation. Although not shown, a support may be connected to legs 610 underneath top 612 in order to provide stability for the top 612 and/or additional storage space for circular-shaped side tables 600A-2-600B-2.

According to various embodiments, magnetic panel 611A-2 and dry-erase panel 611B-2 may be the same or similar to magnetic panel 411A and dry-erase panel 411B, respectively. Thus, magnetic panel 611A-2 and dry-erase panel 611B-2 may provide a structural purpose such that magnetic panel 611A-2 and dry-erase panel 611B-2 are integral to the structure of circular-shaped side tables 600A-2-600B-2 in a same or similar fashion as discussed above with respect to dining tables 400A-400B. Additionally, magnetic panel 611A-2 and/or dry-erase panel 611B-2 may provide a construction purpose such that magnetic panel 611A-2 and/or dry-erase panel 611B-2 are integral to the construction and/or manufacture of side tables 600A-2-600B-2 in a same or similar fashion as discussed above with respect to side tables 600A-1-600B-1. Furthermore, magnetic panel 611A-2 and dry-erase panel 611B-2 may be the same or similar to magnetic panels 411A and dry-erase panel 411B, respectively. Thus, magnetic panels 611A-2 dry-erase panel 611B-2 may be integral to the functionality of circular-shaped side tables 600A-2-600B-2 in a same or similar fashion as discussed above with respect to dining tables 400A-400B.

Magnetic panels 611A-2 may be the same or similar as magnetic panels 111A as discussed above with respect to bed frame 100A. Thus, magnetic panels 611A-2 may include the same or similar properties as magnetic panels 111A, and may be constructed or otherwise manufactured in a similar of same fashion as magnetic panels 111A. Moreover, dry-erase panels 611B-2 may be the same or similar as dry-erase panels 111B as discussed above with respect to bed frame 100B. Thus, dry-erase panels 611B-2 may include the same or similar properties as dry-erase panels 111B, and may be constructed or otherwise manufactured in a similar of same fashion as dry-erase panels 111B.

Although example embodiments are directed to furniture and/or other like objects including magnetic panels, dry-erase panels, and/or chalkboard panels, in addition to numerous features and variations, example embodiments are not to be limited to the specific combinations of features and variations disclosed herein. The principles and features of the disclosed example embodiments may be employed in varied and numerous other example embodiments without departing from the scope of the instant disclosure, as defined by the appended claims. For example, similar furniture and/or frame shapes/styles have been described and illustrated through the example embodiments of the present disclosure. However, these furniture and/or frame shapes/styles are not intended to limit the scope of the present disclosure. It is to be understood different furniture and/or frame shapes/styles may incorporate at least one of a magnetic panel, a dry-erase panel, and/or a chalkboard panel such that the incorporated one of the magnetic panel, the dry-erase panel, and/or the chalkboard panel are integral to the structure and function of the furniture and/or frame. For example, furniture and/or frames may include various bed platforms, bunkbeds, desks, drawers, bureaus, trunks, and/or any other like object intended to support one or more human activities. Furthermore, various example embodiments of incorporating magnetic panels, dry-erase panels, and/or chalkboard panels have been described. It is to be understood that magnetic panels, dry-erase panels, and/or chalkboard panels may be incorporated into a furniture and/or frame in any way that is integral to the structure and/or function of the furniture and/or frame.

The description of the disclosure is merely example in nature and, thus, variations that do not depart from the gist of the disclosure are intended to be within the scope of the disclosure. Such variations are not to be regarded as a departure from the spirit and scope of the disclosure.

What is claimed is:

1. A furniture object comprising:
a writable element,
the writable element being configured to provide for nonpermanent markings,
the writable element being integral to the structure of the furniture object.

2. The furniture object of claim 1, wherein the writable element is integral to the function of the furniture object.

3. The furniture object of claim 1, wherein the nonpermanent markings are erasable.

4. The furniture object of claim 1, wherein a portion of the furniture object including the writable element has a different composition than at least one other portion of the furniture frame.

5. The furniture object of claim 4, wherein the portion of the furniture object including the writable element includes at least one of a whiteboard material, a magnet board material, and a chalk board material.

6. The furniture object of claim 5, wherein the writable element comprises:
a base layer; and
a coating layer.

7. The furniture object of claim 6, wherein the base layer is one of a particle board, wood, steel, and aluminum, and the coating layer is one of a melamine resin, porcelain, ceramic, Polyvinyl chloride (PVC), and epoxy.

8. The furniture object of claim 1, wherein the furniture object is a bed frame and the writable element is at least one of a magnetic panel, dry-erase panel, and chalkboard panel assembled into the bed frame.

9. The furniture object of claim 8, wherein the writable element is assembled into a structure of at least one of a headboard of the bed frame and a footboard of the bed frame.

10. The furniture object of claim 1, wherein the furniture object is a bureau and the writable element is at least one of a magnetic panel, dry-erase panel, and chalkboard panel assembled into the bureau.

11. The furniture object of claim 9, wherein the writable element is assembled into at least one of a structure of a side panel of the bureau, a structure of at least one drawer of the bureau, and a structure of a top surface of the bureau.

12. The furniture object of claim 1, wherein the furniture object is an armoire and the writable element is at least one of a magnetic panel, dry-erase panel, and chalkboard panel assembled into the armoire.

13. The furniture object of claim 12, wherein the writable element is assembled into at least one of a structure of a side panel of the armoire, a structure of at least one door of the armoire, and a structure of a top surface of the armoire.

14. The furniture object of claim 1, wherein the furniture object is a foldable bed frame and the writable element is at least one of a magnetic panel, dry-erase panel, and chalkboard panel assembled into the foldable bed frame.

15. The furniture object of claim 14, wherein the writable element is assembled into a structure of at least one armrest of the foldable bed frame.

16. The furniture object of claim 1, wherein the furniture object is a table and the writable element is at least one of a magnetic panel, dry-erase panel, and chalkboard panel assembled into the table.

17. The furniture object of claim 16, wherein the writable element is assembled into a structure of a top of the table.

18. A furniture object comprising a writable element, the furniture object being manufactured such that the writable element serves at least one construction purpose of the furniture object.

19. The furniture object of claim 18, wherein the furniture object manufactured such that the writable element is incorporated into a structural element of the furniture object, the structural element serving the at least one structural purpose of the furniture object.

20. The furniture object of claim 18, wherein the writable element is assembled into the structural element of the furniture object.

21. The furniture object of claim 18, wherein the writable element is built into spaces defined by a structure of the furniture object.

22. The furniture object of claim 18, wherein the furniture object is manufactured such that the writable element utilizes at least one available surface of the furniture object.

23. The furniture object of claim 18, wherein the furniture object is a bed frame and the writable element serves as one of a headboard and a footboard.

24. The furniture object of claim 18, wherein the writable element includes a temporary drawing surface, the temporary drawing surface comprising:
at least one of a dry-erase material, a chalkboard material, and a magentized material.

25. The furniture object of claim 18, wherein the writable element provides a function of holding at least one object.
